(19) United States
(12) Patent Application Publication
(10) Pub. No.: US 2019/0092456 A1
(43) Pub. Date: Mar. 28, 2019

(54) DUCTS FOR LAMINAR FLOW CONTROL SYSTEMS

(71) Applicant: Airbus Operations Limited, Bristol (GB)

(72) Inventors: David Michael SAWYERS, Bristol (GB); Vernon HOLMES, Bristol (GB)

(21) Appl. No.: 16/142,716

(22) Filed: Sep. 26, 2018

(30) Foreign Application Priority Data
Sep. 28, 2017 (GB) 1715674.6

(51) Int. Cl. B64C 21/10; B64C 9/22; B64C 21/02; F15D 1/00

(52) U.S. Cl. CPC B64C 21/10; B64C 9/22; B64C 2230/22; F15D 1/0055; B64C 2230/04; B64C 21/025

(57) ABSTRACT

An aerodynamic structure including a structural torsion box; a leading edge part fixed to a front side of the torsion box; an air inlet provided on a surface of the leading edge part; and a spanwise extending duct. The air inlet is provided at a first spanwise location, and is for enabling air to flow into an interior of the aerodynamic structure. The duct fluidly connects the air inlet to an air outlet which is spaced apart from the air inlet along a spanwise direction. The duct is within the torsion box.

### FIELD OF THE INVENTION

The present invention relates to an aerodynamic structure, and in particular to an aerodynamic structure for an aircraft, having an air inlet provided on a surface of a leading edge part for enabling air to flow into an interior space within the aerodynamic structure, for example as part of a laminar flow control or boundary layer control system. The present invention also relates to an aircraft having such an aerodynamic structure and a laminar flow control system. Particular examples of the invention are applicable to aircraft wings, with or without leading edge high lift devices.

### BACKGROUND OF THE INVENTION

There is continued focus in the aviation industry on reducing the fuel consumption and emissions of aircraft. It is possible to reduce fuel consumption and emissions by reducing the airframe drag, which can be achieved by ensuring laminar flow over the windswept surfaces of the aerodynamic structures of the aircraft (e.g. wings, vertical and horizontal tailplanes, nacelles and the like). The shape of an aerodynamic structure can be designed to help maintain a laminar boundary layer.

Hybrid laminar flow control (HLFC) systems have been considered for aircraft in an attempt to stabilize the laminar boundary layer. These systems typically work by applying a negative pressure to the inner surface of the aircraft skin, at the windswept surfaces. The term “negative pressure” in this context refers to a pressure less than the pressure at the windswept surface (i.e. negative with respect to a zero-referenced pressure at the windswept surface). The negative pressure can be applied, for example, by sucking air through a porous aircraft skin. The suction can be achieved either by passive or active means.

Incorporating a HLFC system into an aircraft aerodynamic structure such as a wing is challenging, as space within the structure is limited and other systems such as high-lift/shielding devices and/or ice protection systems may also need to be accommodated.

### SUMMARY OF THE INVENTION

A first aspect of the invention provides an aerodynamic structure. The aerodynamic structure comprises: a structural torsion box; a leading edge part fixed to a front side of the torsion box; an air inlet provided on a surface of the leading edge part; and a spanwise extending duct. The air inlet is at a first spanwise location, and is for enabling air to flow into an interior of the aerodynamic structure. The duct fluidly connects the air inlet to an air outlet which is spaced apart from the air inlet along a spanwise direction. The duct is comprised within the torsion box.

Optionally, the duct is integrated with a component of the torsion box. The duct may, for example, be integrated with one or more of: a front spar, an upper cover, a lower cover.

Optionally, the duct is rearward of a front spar of the torsion box.

Optionally, the duct extends for substantially the entire spanwise length of the aerodynamic structure.

Optionally, the air inlet is comprised in a plurality of air inlets on a surface of the leading edge part, wherein the plurality of air inlets is arranged in a distribution which extends over at least part of the spanwise length of the aerodynamic structure, and wherein each air inlet of the plurality of air inlets is fluidly connected to the duct.

Optionally, the aerodynamic structure further comprises at least one further air inlet provided on a surface of the torsion box, wherein the at least one further air inlet is fluidly connected to the duct.

Optionally, the aerodynamic structure comprises a skin and at least a section of the skin forming the surface of the leading edge part is porous, and the air inlet comprises one or more holes comprised in the porous skin section. Optionally, the air inlet comprises one or more slots in a section of the skin forming the surface of the leading edge part.

Optionally, the duct is comprised in a hybrid laminar flow control (HLFC) system configured to suck air into the inlet and expel the intaken air out from the outlet during flight. The HLFC system may be one of: a passive HLFC system configured to use an air pressure differential between the inlet and the outlet to drive the suction; and an active HLFC system, comprising a pump fluidly connected to the duct between the inlet and the outlet.

Optionally, the leading edge part comprises one or more of: a Krueger flap; a slat; a Fixed Leading Edge skin.

Optionally, the inlet is connected to the duct via a hole provided in a front spar of the torsion box.

Optionally, the aerodynamic structure is an aircraft wing.

A second aspect of the invention provides an aircraft. The aircraft comprises an aerofoil, a Hybrid Laminar Flow Control (HLFC) system, and a duct. The aerofoil is formed by a leading edge structure, a torsion box, and a trailing edge structure, and has an aerodynamic surface formed by an outer skin. The HLFC system is configured to suck air into an inlet provided in the aerofoil outer skin at a first spanwise location and to expel air from an outlet provided at a second, different spanwise location, during flight of the aircraft. The duct extends between the inlet and the outlet, and is disposed within the torsion box for at least part of its length.

### BRIEF DESCRIPTION OF THE DRAWINGS

Embodiments of the invention will now be described with reference to the accompanying drawings, in which:

FIG. 1 shows a schematic cross-section through an example aerodynamic structure;

FIG. 2 shows schematic front views of two different example front spars for the aerodynamic structure of FIG. 1;

FIG. 3 shows schematic partial cross-sections through various example front spars for an example aerodynamic structure;

FIG. 4a is a perspective view of an example aircraft; and

FIG. 4b is a schematic plan view of a wing of the aircraft of FIG. 4a.

### DETAILED DESCRIPTION OF EMBODIMENT(S)

The examples described below relate to aerodynamic structures. Each example aerodynamic structure comprises a structural torsion box and a leading edge part fixed to a front side of the torsion box. An air inlet is provided on a surface of the leading edge part, at a first spanwise location, for enabling air to flow into an interior space within the wing. Each example aerodynamic structure also comprises a spanwise extending duct, which fluidly connects the air inlet to an air outlet which is spaced apart from the air inlet along a spanwise direction. In each example, the duct is comprised within the torsion box. “Within the torsion box” is intended to mean within an outer periphery of the torsion box, where the outer periphery is defined by the outer surfaces of the components defining the torsion box (which may typically be spars and covers). Therefore, a duct is considered to be within the torsion box if it is formed integrally with a component which defines the torsion box, or if it is within an internal space enclosed by the components which define the torsion box.

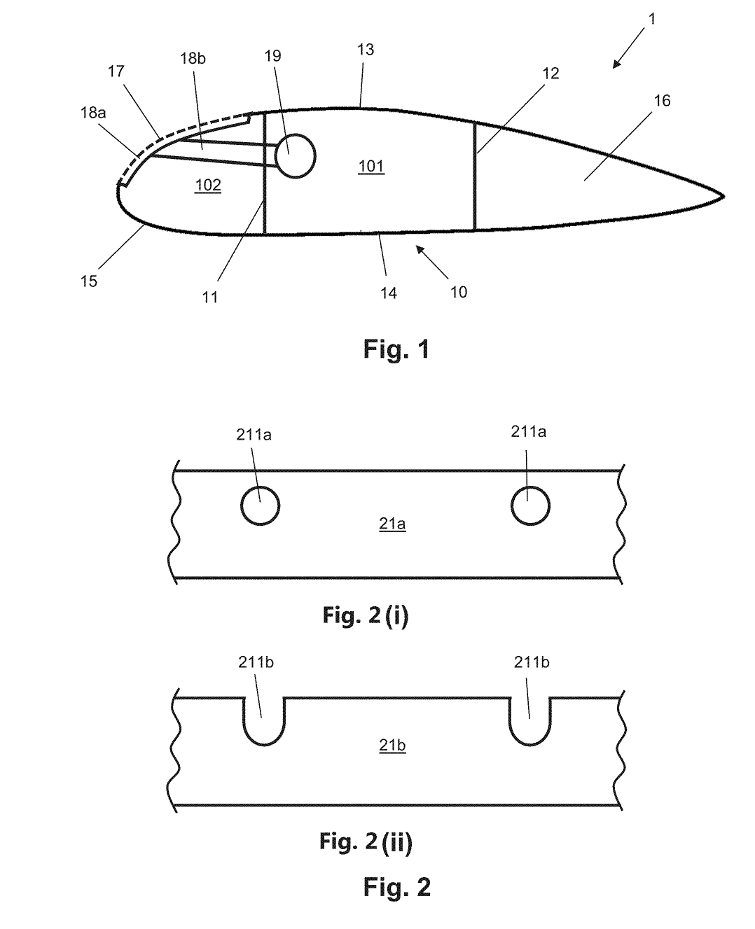

FIG. 1 shows a cross-section through an example aerodynamic structure according to the invention. The example aerodynamic structure is a wing 1. The wing 1 has a structural torsion box (wing box) 10, which carries the main flight loads and the weight of the wing when the aircraft is on the ground. The illustrated example torsion box 10 is formed by a front spar 11, a rear spar 12, an upper cover 13, and a lower cover 14, although other constructions are possible. For example, two or more of these elements of the torsion box 10 may be formed by a single unitary component. The torsion box 10 defines an internal space 101, which in some examples may comprise one or more fluid-tight chambers. In some examples at least part of the internal space 101 within the torsion box 10 comprises a fuel tank. A leading edge part 15 is fixed to the front side of the torsion box 10, and a trailing edge part 16 is fixed to a rear side of the torsion box 10. The trailing edge part is not relevant to the invention and will therefore not be discussed further.

The wing 1 further comprises features which form part of a Hybrid Laminar Flow Control (HLFC) system of the aircraft. In particular, air inlets 17 are provided on a surface of the leading edge part 16 to enable air to flow into an interior of the wing 1. In the particular example the air inlets 17 are provided on an upper surface of the leading edge part 16, however; in other examples the air inlets may alternatively or additionally be provided on a lower surface and/or a leading edge surface of the leading edge part 16. The air inlets 17 are fluidly connected to a spanwise extending duct 19, which is fluidly connected to an air outlet (not shown) to expel air from the interior of the wing 1. The HLFC system is configured to suck air into the air inlets 17 and to expel the intake air out from the air outlet during flight. The HLFC system may be a passive system which is configured to use an air pressure differential between the air inlets 17 and the air outlet to drive the suction, or it may be an active system, comprising a pump fluidly connected to the duct 19 between the air inlets 17 and the air outlet.

The duct 19 is comprised within the torsion box 10. In particular, the duct 19 is disposed rearward of the front spar 11, such that it is within the internal space 101 enclosed by the spars 11, 12 and covers 13, 14. In the illustrated example, the duct 19 is not integrated with any of the components of the torsion box 10, but instead is a separate component disposed within the torsion box 10. In the illustrated example the duct 19 extends for substantially the entire spanwise length of the wing 1. Other examples are possible in which the duct 19 extends for only a part of the spanwise length of the wing 1. The cross-sectional shape and area of the duct 19 may be selected based on a desired airflow to be achieved through the duct during operation of the HLFC system. The cross-sectional shape and/or area of the duct 19 may vary along the span. The cross-sectional area of the duct 19 may be at least 50 mm². The cross-sectional area of the duct 19 may be at least 1000 mm². The cross-sectional area of the duct 19 may be at least 10000 mm². In some examples the cross-sectional area of the duct 19 may be in the range 10000 mm² to 75000 mm². Moreover, although the illustrated duct 19 has a circular cross-section, any other shape could in principle be used.

In the particular example the air outlet comprises a root end of the duct 19, which is configured to connect to a further duct provided in the fuselage of an aircraft on which the wing 1 is installed. The further duct may lead to a further air outlet in an outer skin of the fuselage, for expelling air from the duct 19 to the external environment. Other examples are possible in which the air outlet comprises an opening in the outer skin of the wing 1, in which case the duct 19 may not be configured to connect to a further duct in the fuselage. In all examples, the air outlet is spaced apart from at least one of the air inlets 17 along a spanwise direction.

In the illustrated example, the air inlets 17 are formed by pores of a porous section of the outer skin of the wing 1. Such a porous skin section may be formed, for example, by laser drilling. In other examples, the air inlets 17 may comprise slots in the skin. The porous skin section forms part of a surface of the leading edge part 15 of the wing 1. In the particular example the porous skin section extends over substantially all of the spanwise length of the wing 1. However, in other examples the porous skin section may extend over only a part of the spanwise length of the wing 1. In some examples the leading edge skin may comprise plurality of discrete porous skin sections, distributed along the spanwise length of the wing 1. In these and other examples the air inlets 17 are arranged in a distribution which extends over at least part of the spanwise length of the wing 1. The distribution may extend over substantially all of the spanwise length of the wing 1. The distribution may extend over at least part of the chordwise length of the leading edge part 15. The distribution may extend over substantially all of the chordwise length of the leading edge part 15. In some examples the distribution may extend over part of the upper cover 13 and/or the lower cover 14.

The duct 19 is fluidly connected to each of the air inlets 17. The fluid connection may be formed by any suitable means. In the particular illustrated example, a receiving chamber 18a is provided within an internal space 102 of the leading edge part 15, behind the porous skin section. At least part of an outer wall of the receiving chamber is formed by the porous skin section. The receiving chamber is an enclosed space which prevents air which has entered the air inlets 17 from flowing into the main internal space 102 within the leading edge part 15. In the particular example, the leading edge part 15 comprises a Krueger flap (not shown), meaning that the internal space 102 is not sealed off from the external environment when the Krueger flap is deployed. The receiving chamber 18a ensures that the HLFC system can operate even when the Krueger flap is deployed. In other examples in which the leading edge part 15 does not comprise a Krueger flap, the internal space 102 may serve as a receiving chamber, such that a separate receiving chamber is not required.

The receiving chamber 18a is fluidly connected to series of feeder ducts 18b (only one is visible in FIG. 1), which are in turn fluidly connected to the duct 19. The feeder ducts 18b are spaced along the spanwise length of the wing 1. The number, configuration and arrangement of the feeder ducts 18b may be selected in dependence on the particular application. In the illustrated example the feeder ducts 18b comprise circular-cross-section tubes. Each feeder duct 18b passes through an opening in the front spar 11. FIG. 2 shows two different example front spars 21a, 21b, each of which is suitable for use as the front spar 11 of the example wing 1.

The first example front spar 21a comprises openings in the form of circular holes 211a, of substantially equal diameter to the feeder ducts 18b. Such holes may facilitate creating a seal between the feeder ducts 18b and the front spar 21a, and may therefore be particularly suitable for use in locations where the front spar 21a forms a wall of a fuel tank. The holes 221a are circular in order to conform to the cross-sectional shape of the feeder ducts 18b. In other examples the feeder ducts may have non-circular cross-sections, in which cases the holes 221a may be shaped to conform to the cross-sectional shape (that is, the outer surface) of the non-circular feeder ducts.

The second example front spar 21b comprises openings in the form of notches 211b extending downwardly from the top edge of the front spar 21b. The width of each notch 211 is substantially equal to the diameter of the feeder ducts 18b, and in the illustrated example the base of each notch is shaped to conform to the cross-sectional shape of the corresponding feeder duct 18b. However; the notches may be of any shape or size suitable for receiving the feeder ducts 18b. In some examples notches may be preferable to holes, for example because a spar comprising notches may be relatively easier to manufacture, and/or may be relatively more structurally efficient.

Alternative examples are envisaged in which at least some of the air inlets 17 are connected to the duct 19 via an air passage comprised in a rib of the leading edge part 15. For example, one or more ribs (not shown) comprised in the leading edge part 15 may include a hollow portion extending between a leading edge part of the rib and a trailing edge part of the rib. The hollow portion may be in fluid communication with the receiving chamber 18a, and also with the duct 19. The fluid connection between the hollow portion of the rib and the duct may be via an opening in the front spar 11. The hollow rib portion may therefore replace one or more of the feeder ducts 18b. Some example wings may use hollow ribs in place of feeder ducts, whereas others may use a mixture of hollow ribs and feeder ducts.

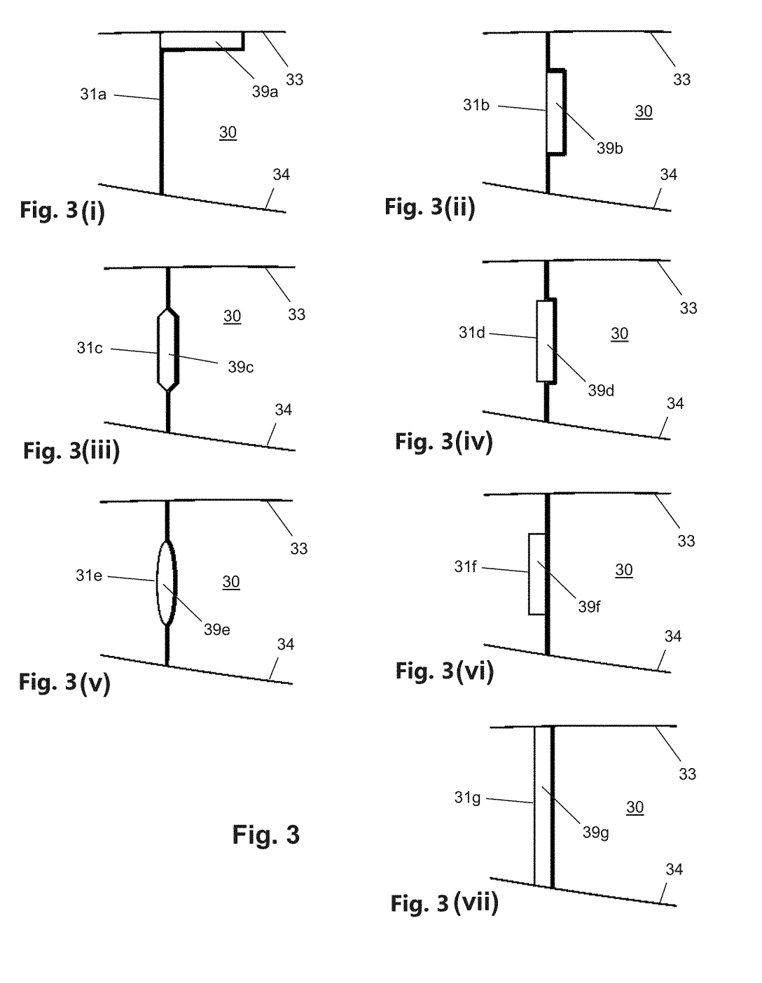

In FIG. 1, the duct 19 is formed as a separate component to the wing box 10. However; in other examples the duct may be formed integrally with one or more of the wing box components. Various options are envisaged for the configuration of an integral duct, seven of which are shown in FIGS. 3(i)-(vii). FIGS. 3(i)-(vii) show part of a cross-section through an example wing box 30 comprising a front spar 31a-g, an upper cover 33, and a lower cover 34. The bold lines in each Figure show the boundary of the main internal chamber of the wing box 30, which may define a fuel tank. Each of the example integral ducts 39a-g shown in FIG. 3 is suitable for use with the example wing 1 of FIG. 1.

In FIG. 3(i) the duct 39a is formed between the front spar 31a and the upper cover 33. In some examples the duct 39a may be formed by a hollow stringer of the upper cover 33. In some examples the duct 39a may be partially defined by the upper cover 33 and partially defined by the front spar 31a. It will be appreciated that a duct having the configuration of the duct 39a can be formed either by a conventional front spar in combination with a specially-shaped upper cover, or by a conventional upper cover in combination with a specially-shaped front spar. Moreover; a duct having substantially the same configuration as the duct 39a could be formed between the front spar 31a and the lower cover 34.

In FIGS. 3(ii)-(vi), each of the ducts 39b-f is formed integrally with the front spar 31. In each of these examples the front spar 31b-f is specially-shaped to comprise a spanwise extending hollow portion, which forms the duct 39b-f. In FIG. 3(ii) the front spar 31b is shaped to have a flat leading edge surface, and a trailing edge surface comprising a rectangular cross-section bulge. The duct 39a is accommodated within the bulge. In FIG. 3(iii) the front spar 31c is shaped to have a bulge in both the leading edge surface and the trailing edge surface, and the duct 39c is defined by the two bulges. The front spar 31d of FIG. 3(iv) is similar to the front spar 31c, except that the bulges are shaped to define a rectangular-cross-section duct 39d whereas the duct 39c has a hexagonal cross-section. The front spar 31e of FIG. 3(v) is similar to the front spars 31c and 31d, except that the bulges are shaped to define an oval-cross-section duct 39e. The front spar 39f of FIG. 3(vi) is similar to the front spar 39b of FIG. 3(ii), except that the rectangular bulge is comprised in the leading edge surface, whilst the trailing edge surface is flat. The front spar 39g of FIG. 3(vii) is hollow for substantially the full height of the spar, thereby defining a substantially rectangular-cross-section duct which extends between the upper cover 33 and the lower cover 34.

The front spars 31a-g and the cover panels 33 may be either metallic or composite. Specially-shaped front spars and upper (or lower) covers such as those shown in FIG. 3 may be manufactured using any suitable known manufacturing technique.

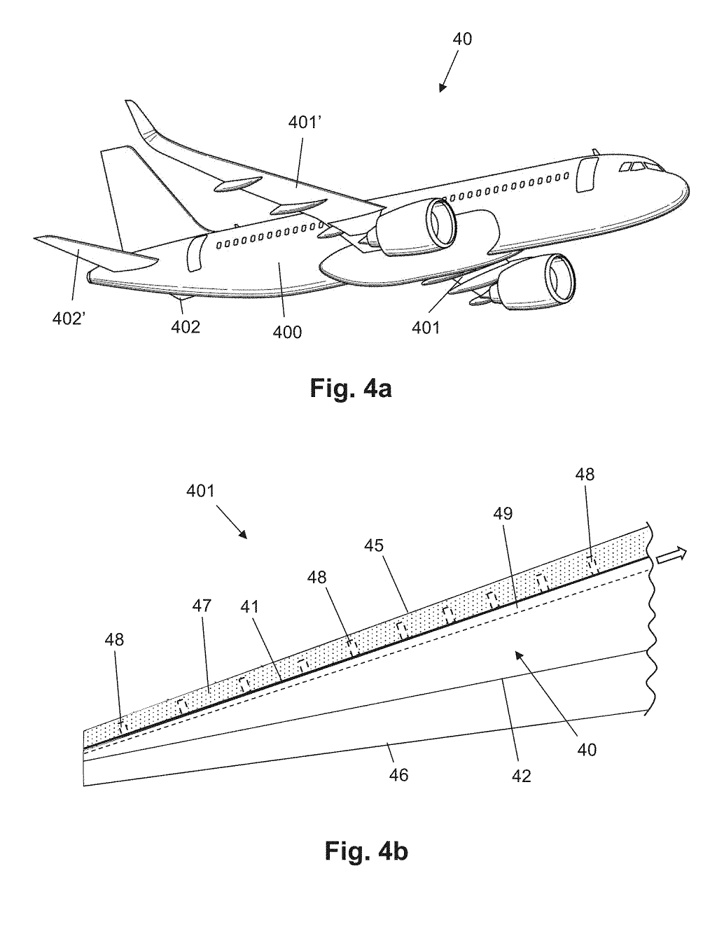

FIG. 4a shows an example aircraft 40 comprising a fuselage 400 and an aerodynamic structure according to the invention. In this example the aerodynamic structure is a wing 401. A plan view of the top surface of the wing 401 is shown in FIG. 4b. The wing 401 comprises an aerofoil formed by a leading edge structure 45, a wing box 40, and a trailing edge structure 46, and has an aerodynamic surface formed by an outer skin. The wing box 40 is formed by a front spar 41, a rear spar 42, an upper cover 43 and a lower cover (not visible). The components of the wing 401 may have the same features as the corresponding components of the example wing 1 of FIG. 1 described above.

The aircraft 40 further comprises a HLFC system configured to suck air into an inlet provided in the aerofoil outer skin at a first spanwise location and to expel air from an outlet provided at a second, different spanwise location, during flight of the aircraft. In the illustrated example the inlet comprises a plurality of openings 47 formed in the skin of the leading edge part 45 and the outlet comprises an exhaust opening (not visible) formed in the outer skin of the fuselage, near the wing root. A duct 49 extends between the inlet 47 and the outlet. The duct 49 is disposed within the wing box 40 for at least part of its length. The inlet openings are connected to the duct 49 by a series of spanwise-spaced feeder ducts 48. The duct 49 and the components of the HLFC system may have the same features as the corresponding components of the example wing 1 of FIG. 1.

In the illustrated example, the duct 49 extends along substantially the entire length of the wing 401. However, other examples are possible in which the duct extends along a part of the spanwise length of the wing 401. In some such examples, the air inlet openings 47 are distributed along only a part of the spanwise length of the wing 401, and the duct 49 extends along the part of the wing which has air inlet openings 47. In other such examples multiple ducts 49 are provided, each of which extends along a different spanwise part of the wing 401. In such examples, each duct 49 may be connected to a different set of inlet openings 47. Each duct 49 may be connected to a different outlet, or multiple ducts 49 may be connected to a common outlet.

The aircraft 40 comprises a further aerodynamic structure according to the invention, in the form of a second wing 401′. The second wing 401′ may have corresponding features to the first wing 401. The aircraft 40 comprises further aerodynamic structures in the form of a pair of tailplanes 402, 402′. Any or all of these further aerodynamic structures may be aerodynamic structures according to the invention.

Although the invention has been described above with reference to one or more preferred embodiments, it will be appreciated that various changes or modifications may be made without departing from the scope of the invention as defined in the appended claims.

The word “or” as used herein is to be taken to mean “and/or” unless explicitly stated otherwise.

1. An aerodynamic structure comprising:
a structural torsion box;
a leading edge part fixed to a front side of the torsion box;
an air inlet provided on a surface of the leading edge part, at a first spanwise location, for enabling air to flow into an interior of the aerodynamic structure; and
a spanwise extending duct, which fluidly connects the air inlet to an air outlet which is spaced apart from the air inlet along a spanwise direction, wherein the duct is within the torsion box.

2. The aerodynamic structure according to claim 1, wherein the spanwise extending duct is integrated with a component of the torsion box.

3. The aerodynamic structure according to claim 2, wherein the spanwise extending duct is integrated with one or more of: a front spar, an upper cover, and a lower cover.

4. The aerodynamic structure according to claim 1, wherein the spanwise extending duct is rearward of a front spar of the torsion box.

5. The aerodynamic structure according to claim 1, wherein the spanwise extending duct extends for substantially the entire spanwise length of the aerodynamic structure.

6. The aerodynamic structure according to claim 1, wherein the air inlet comprises a plurality of openings in the surface of the leading edge part, and the plurality of openings are arranged in a distribution which extends over at least part of the spanwise length of the aerodynamic structure, and each of the openings is fluidly connected to the duct.

7. The aerodynamic structure according to claim 1, further comprising at least one further air inlet provided on a surface of the torsion box, wherein the at least one further air inlet is fluidly connected to the duct.

8. The aerodynamic structure according to claim 1, wherein the aerodynamic structure comprises a skin, wherein at least a section of the skin forming the surface of the leading edge part is porous, and the air inlet is formed by pores in the section of the skin.

9. The aerodynamic structure according to claim 1, wherein the spanwise extending duct is in a hybrid laminar flow control system configured to suck air into the inlet.

10. The aerodynamic structure according to claim 9, wherein the hybrid laminar flow control system is one of:
a passive hybrid laminar flow control system configured to use an air pressure differential between the inlet and the outlet to drive the suction; and
an active hybrid laminar flow control system, comprising a pump fluidly connected to the duct between the inlet and the outlet.

11. The aerodynamic structure according to claim 1, wherein the leading edge part comprises one or more of: a Krueger flap; a slat; and a Fixed Leading Edge skin.

12. The aerodynamic structure according to claim 1, wherein the inlet is connected to the duct via a hole provided in a front spar of the torsion box.

13. The aerodynamic structure according to claim 1, wherein the aerodynamic structure is an aircraft wing.

14. An aircraft, comprising:
an aerofoil formed by a leading edge structure, a torsion box, and a trailing edge structure, and having an aerodynamic surface formed by an outer skin;
a Hybrid Laminar Flow Control system configured to suck air into an inlet provided in the aerofoil outer skin at a first spanwise location and to expel air from an outlet provided at a second, different spanwise location, during flight of the aircraft; and
a duct extending between the inlet and the outlet, disposed within the torsion box for at least part of a length of the duct.

15. An aerodynamic structure comprising:
a torsion box including a front spar;
a leading edge skin attached to and extending forward of the front spar, wherein the leading edge skin extends a span of the torsion box;
a porous portion of the leading edge skin;
a receiving chamber attached to and enclosed by the leading edge skin, wherein the receiving chamber is open to the porous portion of the leading edge such that a portion of laminar air flowing over the leading edge skin passes through the porous portion and enters the receiving chamber;
at least one feeder duct having a first end open to the receiving chamber and the at least one feeder duct extending towards the front spar;
a spanwise extending duct mounted to the front spar which includes an inlet open to a second end of the at least one feeder duct, wherein the at least one feeder duct forms an air passage open to both the receiving chamber and the spanwise extending duct.

16. The aerodynamic structure of claim 15 wherein the at least one feeder duct is a series of feeder ducts regularly spaced along the span of the torsion box.

17. The aerodynamic structure of claim 15 wherein the spanwise extending duct and the front spar such are a single piece component.

18. The aerodynamic structure of claim 15 wherein the spanwise extending duct is on or integral with a rear surface of the front spar.

19. The aerodynamic structure of claim 18 wherein the at least one feeder duct extends through notches or holes in the front spar.

20. The aerodynamic structure of claim 15 wherein the leading edge skin and the torsion box form portions of a wing.
